(19) United States
(12) Patent Application Publication
(10) Pub. No.: US 2015/0132669 A1
(43) Pub. Date: May 14, 2015

(54) PROCESS FOR PRODUCING A CARBON-SUPPORTED MANGANESE OXIDE CATALYST AND ITS USE IN RECHARGEABLE LITHIUM-AIR BATTERIES

(71) Applicant: BASF SE, Ludwigshafen (DE)

(72) Inventors: Arnd Garsuch, Ludwigshafen (DE); Hubert Gasteiger, Muenchen (DE); Cueneyt Kavakli, Muenchen (DE)

(73) Assignee: BASF SE, Ludwigshafen (DE)

(21) Appl. No.: 14/400,860

(22) PCT Filed: Apr. 30, 2013
(86) PCT No.: PCT/IB2013/053397

§ 371 Date: Nov. 13, 2014

Related U.S. Application Data
(60) Provisional application No. 61/650,487, filed on May 23, 2012.

(51) Int. Cl. H01M 4/90; H01M 12/08

(52) U.S. Cl. CPC H01M 4/9083; H01M 12/08; H01M 4/9016
USPC 429/405; 502/182

(57) ABSTRACT

The present invention relates to a process for producing carbon-supported manganese oxide catalysts, to carbon-supported manganese oxide catalysts obtainable or obtained by the process according to the invention, to gas diffusion electrodes comprising said carbon-supported manganese oxide catalysts and to electrochemical cells comprising said gas diffusion electrodes.

The present invention relates to a process for producing carbon-supported manganese oxide catalysts, to carbon-supported manganese oxide catalysts obtainable or obtained by the process according to the invention, to gas diffusion electrodes comprising said carbon-supported manganese oxide catalysts and to electrochemical cells comprising said gas diffusion electrodes.

Secondary batteries, accumulators or “rechargeable batteries” are just some embodiments by which electrical energy can be stored after generation and used when required. Owing to the significantly better power density, there has in recent times been a move away from the water-based secondary batteries toward development of those batteries in which the charge transport in the electrical cell is accomplished by lithium ions.

However, the energy density of conventional lithium ion accumulators which have a carbon anode and a cathode based on metal oxides is limited. New horizons with regard to the energy density were opened up by lithium-sulfur cells and especially by lithium-oxygen or lithium-air cells. In a customary embodiment, a metal, especially lithium, is oxidized with atmospheric oxygen in a nonaqueous electrolyte to form an oxide or peroxide, i.e. in the case of lithium to form Li₂O or Li₂O₂. The energy released is utilized electrochemically. Such batteries can be recharged by reducing the metal ions formed in the course of discharge. It is known that gas diffusion electrodes (GDEs) can be used as the cathode for this purpose. Gas diffusion electrodes are porous and have bifunctional action. Metal-air batteries must enable the reduction of the atmospheric oxygen to oxide or peroxide ions in the course of discharging, and the oxidation of the oxide or peroxide ions to oxygen in the course of charging. For example, it is known that gas diffusion electrodes can be constructed on a carrier material composed of fine carbon which has one or more catalysts for catalysis of the oxygen reduction or oxygen evolution.

For example, A. Débart et al., Angew. Chem. 2008, 120, 4597 (Angew. Chem. Int. Ed. Engl. 2008, 47, 4521) discloses that catalysts are required for such gas diffusion electrodes. Débart et al. mention Co₃O₄, Fe₂O₃, CuO and CoFe₂O₄, and they give reports of α-MnO₂ nanowires and compare them with MnO₂, β-MnO₂, γ-MnO₂, λ-MnO₂, Mn₂O₃ and Mn₃O₄.

H. Cheng et al., J. Power Sources 195 (2010)1370-1374 discloses carbon-supported manganese oxide nanocatalyst for rechargeable lithium-air batteries. Manganese oxide based catalysts were synthesized in the form of nano-particles using a redox reaction of MnSO₄ and KMnO₄, housed into the pores of a carbon matrix and followed by a thermal treatment. Proceeding from this prior art, the object was to find flexible and more efficient synthesis routes to catalysts and to find catalysts, which are improved with regard to at least one of the following properties: electrocatalytic activity, resistance to chemicals, electrochemical corrosion resistance, mechanical stability, good adhesion on the carrier material and low interaction with binder, conductive black and/or electrolyte. In addition, optimization of the costs caused by material and production expenditure should be taken into account, in order to promote the proliferation of this new energy storage technology.

This object is achieved by a process for producing a carbon-supported manganese oxide catalyst comprising

(A) carbon in an electrically conductive polymorph and
(B) manganese oxide of formula (I)

MnOₓ (I),
wherein x is in the range from 1 to 2, in particular in the range from 1.3 to 2
   comprising the process steps of
(a) reduction of permanganate MnO₄⁻ in the presence of a suspension of carbon in an electrically conductive polymorph in at least one aprotic, polar solvent and formation of a carbon-supported manganese oxide, wherein the oxidation state of manganese is in the range from 2 to 4,
(b) isolation of the formed carbon-supported manganese oxide and
(c) optionally thermal treatment of the isolated carbon-supported manganese oxide of process step (b) in a temperature range from 100° C. to 600° C.

In process step (a) of the inventive process permanganate MnO₄⁻ is reduced in the presence of a suspension of carbon (A) in at least one aprotic, polar solvent and formation of a carbon-supported manganese oxide, wherein the oxidation state of manganese is in the range from 2 to 4, particularly preferably in the range from 2.6 to 4.

Permanganate MnO₄⁻ is usually used in form of its salts in the present invention. Preferred salts of permanganate are alkali metal or earth alkali metal salts of permanganate, preferably KMnO₄, RbMnO or Ca(MnO₄)₂, in particular KMnO₄.

Carbon in an electrically conductive polymorph (A) may, in the context of the present invention, also be referred to as carbon (A). Carbon (A) can be selected, for example, from graphite, carbon black, carbon nanotubes, graphene or mixtures of at least two of the aforementioned substances.

In one embodiment of the present invention, carbon (A) is carbon black. Carbon black may, for example, be selected from lamp black, furnace black, flame black, thermal black, acetylene black and industrial black. Carbon black may comprise impurities, for example hydrocarbons, especially aromatic hydrocarbons, or oxygen-containing compounds or oxygen-containing groups, for example OH groups. In addition, sulfur- or iron-containing impurities are possible in carbon black.

In one variant, carbon (A) is partially oxidized carbon black.

In one embodiment of the present invention, carbon (A) comprises carbon nanotubes. Carbon nanotubes (CNT for short), for example single-wall carbon nanotubes (SW CNTs) and preferably multiwall carbon nanotubes (MW CNTs), are known per se. A process for production thereof and some properties are described, for example, by A. Jess et al. in Chemie lngenieur Technik 2006, 78, 94-100.

Graphene in the context of the present invention is understood to mean almost ideally or ideally two-dimensional hexagonal carbon crystals which have an analogous structure to individual graphite layers.

In a preferred embodiment of the present invention, carbon (A) is selected from graphite, graphene, activated carbon and especially carbon black.

Carbon (A) may be present, for example, in particles which have a diameter in the range from 0.1 to 100 μm, preferably 2 to 20 μm. The particle diameter is understood to mean the mean diameter of the secondary particles, determined as the volume average.

In one embodiment of the present invention, carbon (A) and especially carbon black has a BET surface area in the range from 20 to 1500 m²/g, measured according to ISO 9277.

In one embodiment of the present invention, at least two, for example two or three, different kinds of carbon (A) are mixed. Different kinds of carbon (A) may differ, for example, with regard to particle diameter or BET surface area or degree of contamination.

In one embodiment of the present invention, the carbon (A) selected is a combination of carbon black and graphite.

In one embodiment of the present invention, the inventive process is characterized in that the carbon in an electrically conductive polymorph (A) is selected from carbon black.

In process step (a) of the inventive process the reduction of permanganate MnO₄⁻ takes place in the presence of a suspension of carbon (A) in at least one aprotic, polar solvent. Aprotic, polar solvents are known as such. The characteristics of aprotic, polar solvents are the absence of hydrogen bonding, the absence of acidic hydrogen bound to an oxygen atom or a nitrogen atom and the ability to stabilize ions. Examples of aprotic, polar solvents are dichloromethane, tetrahydrofuran, ethyl acetate, acetone, dimethylformamide, acetonitrile or dimethyl sulfoxide. A preferred aprotic, polar solvent is acetone.

Preferably the aprotic, polar solvent which is used in process step a) has the ability to dissolve the salt comprising permanganate and has the ability to suspend carbon (A) easily.

In one embodiment of the present invention, a single aprotic, polar solvent or a mixture of two or more organic solvents comprising at least one aprotic, polar solvent can be used in process step a). Preferably the amount of aprotic, polar solvents in a mixture of two or more organic solvents is at least 80%, more preferably at least 90% up to 100% by weight of the mixture of organic solvents.

In one embodiment of the present invention, the inventive process is characterized in that in process step (a) the aprotic, polar solvent is acetone. Preferably the amount of acetone in a mixture of two or more organic solvents is at least 80%, more preferably at least 90%, in particular between 95 and 100% by weight of the sum of the organic solvents.

The aprotic, polar solvent or the mixture of two or more organic solvents comprising at least one aprotic, polar solvent, in particular acetone, are usually miscible with water. While water dissolves salts comprising permanganate, water does not suspend carbon (A) easily. Preferably the amount of water in the aprotic, polar solvent or the mixture of two or more organic solvents comprising at least one aprotic, polar solvent is not more than 10%, preferably not more than 5% by weight of the sum of the organic solvents.

In one embodiment of the present invention, the inventive process is characterized in that the reduction of permanganate MnO₄⁻ in process step (a) takes place in the presence of water in an amount of 0.001 to 10%, preferably in an amount of 0.001 to 5% by weight based on the sum of the aprotic, polar solvents.

The reduction of permanganate MnO₄⁻ in process step (a) can take place in a wide temperature range. Depending on the freezing point and boiling point of the solvent or mixture of solvents used to dissolve the salt comprising permanganate and to suspend carbon (A) a reaction temperature can be chosen. If the reaction takes place under pressure, for examples in an autoclave, the reaction temperature can be higher than the atmospheric pressure boiling point of the used solvent. The reduction of permanganate MnO₄⁻ in process step (a) is preferably carried out in a temperature range between −70° C. and 150° C., preferably in a temperature range between 0° C. and 100° C., particularly preferably in a temperature range from 20 to 80° C., especially from 20 to 55° C.

In one embodiment of the present invention, the inventive process is characterized in that process step (a) takes place at a temperature in the range from 20 to 80° C., preferably from 20 to 55° C.

In process step (a) permanganate MnO₄⁻, wherein the oxidation state of manganese is +7, is reduced to manganese oxide, wherein the oxidation state of manganese is in the range from 2 to 4, in particular from 2.6 to 4 by a reducing agent, which is oxidized. The reducing agent can be carbon (A), one of the solvents used in process step a) or any other additionally added reducing agent. It is known that acetone itself can be oxidized by permanganate MnO₄⁻. An example of an additionally added reducing agent is manganese in the oxidation state +2, for example in form of a salt like manganese sulfate. Preferably permanganate MnO₄⁻ is reduced by carbon (A).

In process step (a) the ratio between permanganate MnO₄⁻ and carbon (A) can be varied in a wide range. Preferably the ratio by weight between permanganate MnO₄⁻ and carbon (A) is in the range from 1 to 1000 to 10 to 1, particularly preferably in the range from 1 to 100 to 2 to 1, especially in the range from 1 to 10 to 1 to 1.

In process step (a) permanganate MnO₄⁻ and the reducing agent can be combined in different ways. For example it is possible to add permanganate MnO₄⁻ to the reducing agent or vice versa or to add permanganate MnO₄⁻ and a reducing agent simultaneously to a suspension of carbon (A). Preferably permanganate MnO₄⁻ is added to the suspension of carbon (A) comprising optionally a reducing agent different from carbon (A).

In one embodiment of the present invention, the inventive process is characterized in that in process step (a) a solution of KMnO₄⁻ in acetone is added drop-wise to a suspension of carbon black in acetone in a temperature range from 20° C. to 55° C.

In process step b) the carbon-supported manganese oxide, which is formed in process step a), is isolated. Methods for the separation of solids from fluids are generally known. For example in process step b) the carbon-supported manganese oxide can be isolated from the liquid by decantation, filtration or centrifugation. The isolation of the carbon-supported manganese oxide may also comprise additional washing steps and/or at least one drying step in order to remove adhering solvents. The carbon-supported manganese oxide can be dried on completion of the washing procedure. The drying procedure is not critical per se. The drying temperature is usually not higher than the boiling temperature of the solvent used for washing. If the drying step takes place under reduced pressure the drying temperature can be significantly reduced below the boiling temperature of the adhering solvent. A flowable carbon-supported manganese oxide can be obtained already after partial drying.

In the optional process step c) the isolated carbon-supported manganese oxide of process step (b) is thermally treated in a temperature range from 100° C. to 600° C., preferably in a temperature range from 100° C. to 220° C. During thermal treatment the carbon-supported manganese oxide is further dried and/or the structure and/or stoichiometry of the manganese oxide are changed.

The present invention further also provides a carbon-supported manganese oxide catalyst comprising

(A) carbon in an electrically conductive polymorph and
(B) manganese oxide of formula (I)

MnOₓ (I),
wherein x is in the range from 1 to 2, particularly preferably in the range from 1.3 to 2,
   obtainable by a process for producing a carbon-supported manganese oxide catalyst as described above. This process comprises the above-described process steps a), b) and optionally c), especially also with regard to preferred embodiments thereof.

The present invention likewise also provides a carbon-supported manganese oxide catalyst comprising

(A) carbon in an electrically conductive polymorph and
(B) manganese oxide of formula (I)

MnOₓ (I),
wherein x is in the range from 1 to 2, particularly preferably in the range from 1.3 to 2,
   wherein the catalyst is prepared by a process comprising the process steps of
(a) reduction of permanganate MnO₄⁻ in the presence of a suspension of carbon in an electrically conductive polymorph in at least one aprotic, polar solvent and formation of a carbon-supported manganese oxide, wherein the oxidation state of manganese is in the range from 2 to 4,
(b) isolation of the formed carbon-supported manganese oxide and
(c) optionally thermal treatment of the isolated carbon-supported manganese oxide of process step (b) in a temperature range from 100° C. to 600° C.

The process steps a), b) and optionally c) have been described above. In particular, preferred embodiments of the process steps have been described above.

The carbon-supported manganese oxide catalyst, also called catalyst (C) for short hereinafter, which is obtainable or obtained by the inventive process, comprises as component (A) carbon (A) in an electrically conductive polymorph and as component (B) manganese oxide of the formula MnOₓ, wherein x is in the range from 1 to 2, particularly preferably in the range from 1.3 to 2.

Carbon (A), which has been described above in detail, is both the support of the manganese oxide of the formula MnOₓ, which is formed in process step (a), and a reducing agent for permanganate MnO₄⁻.

Manganese oxide of formula MnOₓ, wherein x is in the range from 1 to 2, particularly preferably in the range from 1.3 to 2 is existent in the form of nano-particles, which are uniformly distributed over the carbon support.

At least 15%, preferably at least 20% by weight of the manganese oxide of formula MnO₄, wherein x is in the range from 1 to 2, particularly preferably in the range from 1.3 to 2, are provided in a particle size of smaller than 1 μm, preferably smaller than 10 nm.

In one embodiment of the present invention, manganese oxide of formula MnOₓ is selected from the group consisting disordered δ-MnO₂, γ-MnO₂, ε-MnO₂ and mixtures thereof.

The ratio between manganese oxide of the formula MnOₓ and carbon (A) can be varied in a wide range. Preferably the ratio by weight between manganese Mn and carbon (A) is in the range from 1 to 100 to 10 to 1, particularly preferably in the range from 1 to 20 to 2 to 1, especially in the range from 1 to 4 to 1 to 1.

Catalyst (C) may be present, for example, in particles which have a diameter in the range from 0.1 to 100 μm, preferably 0.3 to 10 μm. The particle diameter is understood to mean the mean diameter of the secondary particles, determined as the volume average. The particles size can be determined according to Transmission Electron Microscopy (TEM) measurement.

In one embodiment of the present invention, catalyst (C) has a BET surface area in the range from 15 to 2000, preferably from 200 to 400 m²/g, measured according to ISO 9277.

In one embodiment of the present invention, Catalyst (C) comprises manganese oxide of formula MnOₓ in the form of disordered δ-MnO₂ or in form of γ-MnO₂ and/or ε-MnO₂.

The inventive carbon-supported manganese oxide catalyst, also called catalyst (C) for short hereinafter, which is obtainable or obtained by the above described inventive process is particularly suitable as a cathode active material for gas diffusion electrodes of an electrochemical cell, in particular of a rechargeable electrochemical cell like a metal-air or metal-oxygen cell. In addition to the carbon-supported manganese oxide catalyst a gas diffusion electrode comprises at least one solid medium through which gas can diffuse and which optionally serves as a carrier for the carbon-supported manganese oxide catalyst. In addition, the inventive gas diffusion electrode may comprise additional carbon in an electrically conductive polymorph and at least one binder.

The present invention further provides a gas diffusion electrode comprising the inventive carbon-supported manganese oxide catalyst as described above and at least one solid medium through which gas can diffuse and which optionally serves as a carrier for the inventive carbon-supported manganese oxide catalyst.

The inventive gas diffusion electrode comprises, as well as the inventive catalyst (C), at least one solid medium, also called medium (M) for short in the context of the present invention, through which gas can diffuse or which optionally serves as a carrier for the inventive catalyst (C).

Media (M) in the context of the present invention are preferably those porous bodies through which oxygen or air can diffuse even without application of elevated pressure, for example metal meshes and gas diffusion media composed of carbon, especially activated carbon, and also carbon on metal mesh.

In one embodiment of the present invention, air or atmospheric oxygen can flow essentially unhindered through medium (M).

In one embodiment of the present invention, medium (M) is a medium which conducts electrical current.

In a preferred embodiment of the present invention, medium (M) is chemically inert toward the reactions which proceed in an electrochemical cell in standard operation, i.e. in the course of charging and in the course of discharging.

In one embodiment of the present invention, medium (M) has an internal BET surface area in the range from 20 to 1500 m²/g, which is preferably determined as the apparent BET surface area.

In one embodiment of the present invention, medium (M) is selected from metal meshes, for example nickel meshes or tantalum meshes. Metal meshes may be coarse or fine.

In another embodiment of the present invention, medium (M) is selected from electrically conductive fabrics, for example mats, felts or nonwovens composed of carbon, which comprise metal filaments, for example tantalum filaments or nickel filaments.

In one embodiment of the present invention, medium (M) is selected from gas diffusion media, for example activated carbon, aluminum-doped zinc oxide, antimony-doped tin oxide or porous carbides or nitrides, for example WC, Mo₂C, Mo₂N, TiN, ZrN or TaC.

In addition, it is possible to apply the inventive catalyst (C) in the form of a liquid formulation preferably together with additional carbon in an electrically conductive polymorph and/or a binder and a suitable solvent or solvent mixture, as described below, to a medium (M), which is an electrically insulating flat material which can typically be used as a separator in electrochemical cells and is described in detail below.

The gas diffusion electrode comprises preferably in addition to catalyst (C) and medium (M) additional carbon in an electrically conductive polymorph and/or at least one binder, also called binder (aa) for short in the context of the present invention.

The additional carbon in an electrically conductive polymorph, also called carbon (A2) for short in the context of the present invention is defined in the same manner as carbon (A). Carbon (A2), the additional carbon, can be identical to or different from carbon (A), which was used in the process for producing catalyst (C). Preferred forms of carbon (A2) are carbon black or graphite or mixtures thereof.

The binder (aa) is typically an organic polymer. Binder (aa) serves principally for mechanical stabilization of catalyst (C), by virtue of catalyst (C) particles and optionally carbon (A2) particles being bonded to one another by the binder, and also has the effect that the catalyst (C) has sufficient adhesion to an output conductor. The binder (aa) is preferably chemically inert toward the chemicals with which it comes into contact in an electrochemical cell.

In one embodiment of the present invention, binder (aa) is selected from organic (co)polymers. Examples of suitable organic (co)polymers may be halogenated or halogen-free. Examples are polyethylene oxide (PEO), cellulose, carboxymethylcellulose, polyvinyl alcohol, polyethylene, polypropylene, polytetrafluoroethylene, polyacrylonitrile-methyl methacrylate copolymers, styrene-butadiene copolymers, tetrafluoroethylene-hexafluoropropylene copolymers, vinylidene fluoride-hexafluoropropylene copolymers (PVdF-HFP), vinylidene fluoride-tetrafluoroethylene copolymers, perfluoroalkyl vinyl ether copolymers, ethylene-tetrafluoroethylene copolymers, vinylidene fluoride-chlorotrifluoroethylene copolymers, ethylene-chlorofluoroethylene copolymers, ethylene-acrylic acid copolymers, optionally at least partially neutralized with alkali metal salt or ammonia, ethylene-methacrylic acid copolymers, optionally at least partially neutralized with alkali metal salt or ammonia, ethylene-(meth)acrylic ester copolymers, polyimides and polyisobutene.

Suitable binders are especially polyvinyl alcohol and halogenated (co)polymers, for example polyvinyl chloride or polyvinylidene chloride, especially fluorinated (co)polymers such as polyvinyl fluoride and especially polyvinylidene fluoride and polytetrafluoroethylene. Of particular suitability are tetrafluoroethylene polymer, or sulfonated tetrafluoroethylene polymer exchanged with lithium ions, which is also referred to as Li-exchanged Nafion®.

The mean molecular weight M_{w} of binder (aa) may be selected within wide limits, suitable examples being 20 000 g/mol to 1 000 000 g/mol.

In one embodiment of the present invention, the gas diffusion electrode comprises in the range from 10 to 60% by weight of binder (aa), preferably 20 to 45% by weight and more preferably 30 to 35% by weight, based on the total mass of catalyst (C), carbon (A2) and binder (aa).

Binder (aa) can be combined with catalyst (C) and carbon (A2) by various processes. For example, it is possible to dissolve a soluble binder (aa) such as polyvinyl alcohol in a suitable solvent or solvent mixture, for example in water/isopropanol, and to prepare a suspension with catalyst (C) and carbon (A2). After application of the suspension to a suitable medium (M), the solvent or solvent mixture is removed, for example evaporated, to obtain an inventive gas diffusion electrode. A suitable solvent for polyvinylidene fluoride is NMP. The application can be accomplished, for example, by spraying, for example spray application or atomization, and also knifecoating, printing or by pressing. In the context of the present invention, atomization also includes application with the aid of a spray gun, a process frequently also referred to as “airbrush method” or “airbrushing” for short.

If it is desirable to use sparingly soluble polymers as binder (aa), for example polytetrafluoroethylene, tetrafluoroethylene-hexafluoropropylene copolymers or Li-exchanged Nafion®, a suspension of particles of the relevant binder (aa), catalyst (C), and also further possible constituents of the gas diffusion electrode like carbon (A2), is prepared and processed as described above to give a gas diffusion electrode.

In addition, the gas diffusion electrode may have further constituents customary per se, for example an output conductor, which may be configured in the form of a metal wire, metal grid, metal mesh, expanded metal, metal sheet or metal foil, stainless steel being particularly suitable as the metal.

Further components of gas diffusion electrode may, for example, also be solvents, which are understood to mean organic solvents, especially isopropanol, N-methylpyrrolidone, N,N-dimethylacetamide, amyl alcohol, n-propanol or cyclohexanone. Further suitable solvents are organic carbonates, cyclic or noncyclic, for example diethyl carbonate, ethylene carbonate, propylene carbonate, dimethyl carbonate and ethyl methyl carbonate, and also organic esters, cyclic or noncyclic, for example methyl formate, ethyl acetate or γ-butyrolactone (gamma-butyrolactone), and also ethers, cyclic or noncyclic, for example 1,3-dioxolane.

In addition, the gas diffusion electrode may comprise water.

In one embodiment of the present invention, gas diffusion electrode has a thickness in the range from 5 to 100 μm, preferably from 10 to 20 μm, based on the thickness without output conductor.

The gas diffusion electrode may be configured in various forms, for example in rod form, in the form of round, elliptical or square columns, or in cuboidal form, especially also as a flat electrode. For instance, it is possible, in the case that medium (M) is selected from metal meshes, that the shape of the gas diffusion electrode is essentially defined by the shape of the metal grid.

In one embodiment of the present invention, a composition, which comprises the inventive catalyst (C), a binder (aa) and optionally carbon (A2), due to its structure, is already self-supporting and gas-pervious, and so it is unnecessary to use a medium (M) as support material, which is permeable to gas.

The present invention further provides for the use of inventive gas diffusion electrodes for production of electrochemical cells, for example for production of non-rechargeable electrochemical cells, which are also referred to as primary batteries, or for production of rechargeable electrochemical cells, which are also referred to as secondary batteries. The present invention further provides an electrochemical cell, preferably a rechargeable electrochemical cell comprising at least one inventive gas diffusion electrode.

In the inventive electrochemical cell, in particular in the rechargeable electrochemical cell, in the course of the discharging operation thereof, a gas is reduced at the gas diffusion electrode, especially molecular oxygen O₂. Molecular oxygen O₂ can be used in dilute form, for example in air, or in highly concentrated form.

Inventive electrochemical cells, in particular rechargeable electrochemical cells further comprise at least one anode, which comprises metallic magnesium, metallic aluminum, metallic zinc, metallic sodium or metallic lithium. The anode preferably comprises metallic lithium. Lithium may be present in the form of pure lithium or in the form of a lithium alloy, for example lithium-tin alloy or lithium-silicon alloy or lithium-tin-silicon alloy.

In a further embodiment of the present invention, the inventive electrochemical cell is a lithium-oxygen cell, for example a lithium-air cell.

In one embodiment of the present invention, inventive electrochemical cells comprise one or more separators by which gas diffusion electrode and anode are mechanically separated from one another. Suitable separators are polymer films, especially porous polymer films, which are unreactive toward metallic lithium, the reaction products formed at the gas diffusion electrode in the discharging operation, and toward the electrolyte in the inventive electrochemical cells. Particularly suitable materials for separators are polyolefins, especially porous polyethylene films and porous polypropylene films.

Polyolefin separators, especially of polyethylene or polypropylene, may have a porosity in the range from 35 to 45%. Suitable pore diameters are, for example, in the range from 30 to 500 nm.

In another embodiment of the present invention, the separators selected may be separators composed of PET nonwovens filled with inorganic particles. Such separators may have a porosity in the range from 40 to 55%. Suitable pore diameters are, for example, in the range from 80 to 750 nm.

Additionally suitable is glass fiber-reinforced paper or inorganic nonwovens, such as glass fiber nonwovens or ceramic nonwovens.

The procedure for production of the inventive electrochemical cells may be, for example, to combine gas diffusion electrode, anode and optionally one or more separators with one another in accordance with the invention and to introduce them into a housing together with any further components. The electrodes, i.e. gas diffusion electrode or anode, may, for example, have thicknesses in the range from 20 to 500 μm, preferably 40 to 200 μm. They may, for example, be in the form of rods, in the form of round, elliptical or square columns, or in cuboidal form, or in the form of flat electrodes.

In a further embodiment of the present invention, above-described inventive electrical cells comprise, as well as the electrodes, a liquid electrolyte comprising a lithium-containing conductive salt.

In one embodiment of the present invention, inventive electrical cells comprise, as well as the gas diffusion electrode and the anode, especially an anode comprising metallic lithium, at least one nonaqueous solvent which may be liquid or solid at room temperature, and is preferably liquid at room temperature, and which is preferably selected from polymers, cyclic and noncyclic ethers, cyclic and noncyclic acetals, cyclic and noncyclic organic carbonates and ionic liquids.

Examples of suitable polymers are especially polyalkylene glycols, preferably poly-C₁-C₄-alkylene glycols and especially polyethylene glycols. These polyethylene glycols may comprise up to 20 mol % of one or more C₁-C₄-alkylene glycols in copolymerized form. The polyalkylene glycols are preferably polyalkylene glycols double-capped by methyl or ethyl. The molecular weight M_{w} of suitable polyalkylene glycols and especially of suitable polyethylene glycols may be at least 400 g/mol.

The molecular weight M_{w} of suitable polyalkylene glycols and especially of suitable polyethylene glycols may be up to 5 000 000 g/mol, preferably up to 2 000 000 g/mol.

Examples of suitable noncyclic ethers are, for example, diisopropyl ether, di-n-butyl ether, 1,2-dimethoxyethane, 1,2-diethoxyethane, preference being given to 1,2-dimethoxyethane.

Examples of suitable cyclic ethers are tetrahydrofuran and 1,4-dioxane.

Examples of suitable noncyclic acetals are, for example, dimethoxymethane, diethoxymethane, 1,1-dimethoxyethane and 1,1-diethoxyethane.

Examples of suitable cyclic acetals are 1,3-dioxane and especially 1,3-dioxolane.

Examples of suitable noncyclic organic carbonates are dimethyl carbonate, ethyl methyl carbonate and diethyl carbonate.

Examples of suitable cyclic organic carbonates are compounds of the general formulae (X) and (XI)

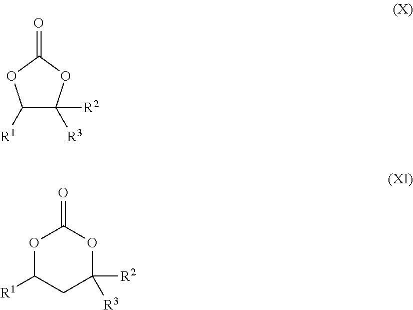

in which R¹, R² and R³ may be the same or different and are selected from hydrogen and C₁-C₄-alkyl, for example methyl, ethyl, n-propyl, isopropyl, n-butyl, isobutyl, sec-butyl and tert-butyl, where R² and R³ are preferably not both tert-butyl.

In particularly preferred embodiments, R¹ is methyl and R² and R³ are each hydrogen, or R¹, R² and R³ are each hydrogen.

Another preferred cyclic organic carbonate is vinylene carbonate, formula (XII).

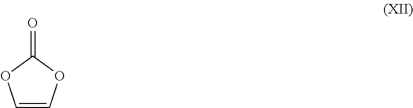

Further preferred solvents are also the fluorinated derivates of the aforementioned solvents, especially fluorinated derivatives of cyclic or noncyclic ethers, cyclic or noncyclic acetals or cyclic or noncyclic organic carbonates, in each of which one or more hydrogen atoms have been replaced by fluorine atoms.

The solvent(s) is (are) preferably used in what is known as the anhydrous state, i.e. with a water content in the range from 1 ppm to 0.1% by weight, determinable, for example, by Karl Fischer titration.

In one embodiment of the present invention, inventive electrochemical cells comprise one or more conductive salts, preference being given to lithium salts. Examples of suitable lithium salts are LiPF₆, LiBF₄, LiClO₄, LiAsF₆, LiCF₃SO₃, LiC(CₙF₂ₙ₊₁SO₂)₃, lithium imides such as LiN(CₙF₂ₙ₊₁SO₂)₂, where n is an integer in the range from 1 to 20, LiN(SO₂F)₂, Li₂SiF₆, LiSbF₆, LiAlCl₄, and salts of the general formula (CₙF₂ₙ₊₁SO₂)ₘXLi, where m is defined as follows:

m=1 when X is selected from oxygen and sulfur,
m=2 when X is selected from nitrogen and phosphorus, and
m=3 when X is selected from carbon and silicon.

Preferred conductive salts are selected from LiC(CF₃SO₂)₃, LiN(CF₃SO₂)₂, LiPF₆, LiBF₄, LiClO₄, particular preference being given to LiPF₆ and LiN(CF₃SO₂)₂.

Examples of suitable solvents are especially propylene carbonate, ethylene carbonate, ethyl methyl carbonate, diethyl carbonate and mixtures of at least two of the aforementioned solvents, especially mixtures of ethylene carbonate with ethyl methyl carbonate or diethyl carbonate.

In one embodiment of the present invention, inventive electrochemical cells may comprise a further electrode, for example as a reference electrode. Suitable further electrodes are, for example, lithium wires.

Inventive electrochemical cells give a high voltage and are notable for a high energy density and good stability. More particularly, inventive electrochemical cells are notable for an improved cycling stability.

The inventive electrochemical cells can be assembled to metal-air batteries, preferably rechargeable metal-air batteries, especially to rechargeable lithium-air batteries.

Accordingly, the present invention also further provides for the use of inventive electrochemical cells as described above in rechargeable metal-air batteries, especially rechargeable lithium-air batteries.

The present invention further provides rechargeable metal-air batteries, especially rechargeable lithium-air batteries, comprising at least one inventive electrochemical cell as described above. Inventive electrochemical cells can be combined with one another in inventive rechargeable metal-air batteries, especially in rechargeable lithium-air batteries, for example in series connection or in parallel connection. Series connection is preferred.

Inventive electrical cells are notable for particularly high capacities, high performances even after repeated charging and greatly retarded cell death. Inventive electrical cells are very suitable for use in motor vehicles, bicycles operated by electric motor, for example pedelecs, aircraft, ships or stationary energy stores. Such uses form a further part of the subject matter of the present invention.

The present invention further provides for the use of inventive electrochemical cells as described above in motor vehicles, bicycles operated by electric motor, aircraft, ships or stationary energy stores.

The use of inventive rechargeable metal-air batteries, especially rechargeable lithium-air batteries, in devices gives the advantage of prolonged run time before recharging and a smaller loss of capacity in the course of prolonged run time. If the intention were to achieve an equal run time with electrochemical cells with lower energy density, a higher weight for electrochemical cells would have to be accepted.

The present invention therefore also further provides for the use of inventive rechargeable metal-air batteries, especially rechargeable lithium-air batteries, in devices, especially in mobile devices. Examples of mobile devices are vehicles, for example motor vehicles, bicycles, aircraft, or water vehicles such as boats or ships. Other examples of mobile devices are those which are portable, for example computers, especially laptops, telephones or electrical power tools, for example from the construction sector, especially drills, battery-driven screwdrivers or battery-driven tackers.

The invention is illustrated by the examples which follow but do not restrict the invention.

Figures in percent are each based on % by weight, unless explicitly stated otherwise.

The elemental compositions of the materials were determined by a CHNS analyzer and colorimetric titration using UV-Vis spectrophotometry for manganese analysis.

### I. Preparation of Carbon-Supported Manganese Oxide Catalysts

I.1 Synthesis of Catalyst-1 0.52 g of carbon black (Vulcan XC-72; N₂ BET surface area: 240 m²/g_{carbon}, primary particle size: 30 nm) and 0.6084 g of MnSO₄.H₂O (Aldrich) were suspended in 150 ml 99.5% acetone in a 500 ml round-bottom flask and heated up to 54° C. Into this suspension, a solution of 0.3787 g KMnO₄⁻ (Aldrich) in 100 ml of acetone was dropwise added while vigorous stirring. The dropping funnel was further washed with 50 ml of acetone. The mixture was left to react under reflux conditions for 1.5 h (including dropwise addition). At the end of the reaction the suspension was cooled down to room temperature and acetone was removed by pipette. The material obtained was washed several times with water and filtered by using polyethersulfone membrane filter (0.2 μm pore size, Pall Corporation, Supor®-200). The black material prepared was first dried at 80° C. in oven for a day and then left in vacuum oven at 70° C. for 16 h. It was then calcined at 220° C. for 16 h in a Büchi oven. The composite prepared in this way is called “Catalyst-1”.

### I.1.a Characterization of Catalyst-1

XRD clearly indicates the formation of disordered birnessite type MnO₂ on carbon black. According to the Scherrer equation the average crystallite size of the formed MnO₂ is 5.4 nm. The carbon percentage was found 66.9% whereas manganese content determined was 27.8%. The amount of potassium is 0.1%.

The specific surface area of the composite material based on the adsorption branch of nitrogen physisorption isotherms is 236 m²/gₘₐₜₑᵣᵢₐₗ.

The morphology and the distribution of MnO₂ on the carbon were analyzed by TEM and SEM techniques. Very fine needle-like MnO₂ is uniformly distributed over the carbon; no obvious agglomeration of MnO₂ is seen.

### I.2 Synthesis of Catalyst-2

2.052 g of carbon black (Vulcan XC-72 as described in example 1.1) was suspended in 50 ml acetone by using ultrasonic bath and heated to 50° C. while continuously stirred under reflux. 0.9089 g of KMnO₄⁻ was dissolved separately in a beaker glass in 100 ml acetone (99.8%, Aldrich), brought to 50° C. and added slowly into this carbon suspension. The beaker was washed further with 50 ml of acetone to get the remaining KMnO₄ and the suspension was further stirred for 15 minutes. The acetone was removed carefully with pipette and the sediment (carbon-MnO₂) was washed with aqueous acetic acid solution (pH: 3.5) and finally filtered by using polyethersulfone membrane filter (0.2 μm pore size, Pall Corporation, Supor®-200). The material was first dried at 80° C. in oven for a day and then left in vacuum oven at 70° C. for 16 h. It was then calcined at 220° C. for 16 h in Büchi oven. The composite prepared in this method is called “Catalyst-2”.

### I.2.a Characterization of Catalyst-2

XRD of Catalyst-2 can be indexed to the γ and/or ε-MnO₂ which are two very close phases of MnO₂ that differ from each other only by the number of structural defects.

The average crystallite size of the formed MnO₂ calculated from Scherrer equation according to the strongest signal at 2⊖: 37.2° is 7.2 nm.

The carbon percentage was found 80.7% whereas manganese content determined was 11.7%.

The specific surface area of the composite material based on the adsorption branch of nitrogen physisorption isotherms is 209 m²/gₘₐₜₑᵣᵢₐₗ.

### II. Electrochemical Testing of Carbon-Supported Manganese Oxide Catalysts

In order to demonstrate the activity of carbon-supported manganese oxide catalysts for H₂O₂ electrooxidation, experiments with a rotating ring disk electrode (RRDE) were performed in a 0.1 M solution of KOH saturated in O₂ and containing 1.2 mM of H₂O₂. The electrode rotation was 1600 rpm and the sweep rate was 20 mV s⁻.

Both carbon-supported manganese oxide (Catalyst-1 and Catalyst-2) catalysts present resembling H₂O₂-oxidation capabilities and are unequivocally much more active than carbon black (Vulcan XC-72) alone. At a relatively low potential of ≈1.0 V_{RHE} (at which H₂O₂-electrooxidation is mostly kinetically controlled) the following current density were measured:

| | 1.0 V_{RHE} | 1.4 V_{RHE} |
|---|---|---|
| Catalyst-1: | 0.92 mA/cm²_{disk} | 1.60 mA/cm²_{disk} |
| Catalyst-2: | 0.64 mA/cm²_{disk} | 1.46 mA/cm²_{disk} |
| Vulcan XC-72 alone | 0.00 mA/cm²_{disk} | 0.20 mA/cm²_{disk} |

To investigate whether the MnO₂ based catalysts can improve the rechargeability of Li—O₂ cells, Li₂O₂ electrochemical decomposition activity of Catalyst-2 was tested and compared with the activity of carbon black Vulcan XC-72.

Preparation of an electrode comprising Catalyst-2 (E-1)

A 1:1 (wt.:wt.) mixture of Li₂O₂ and Catalyst-2 (example 1.2) was added to a 0.67% wt. PEO 400K (Aldrich) solution in toluene (99.5%, <1 ppm water), wherein the ratio by weight of the binder PEO 400K to the carbon support (Vulcan XC-72) of Catalyst-2 is 0.2. The mixture was sonicated under Ar atmosphere for 10 minutes using a Branson 250 digital probe-sonifier. The ink obtained was coated directly on Celgard® C480 using a Meyer-Rod. After evaporation of the solvent at room temperature, 15 mm diameter cathode electrodes were punched out. The electrodes were dried under dynamic vacuum overnight at 50° C. in a glass oven (Büchi, Switzerland) and directly transferred for cell assembly into an argon-filled glove box (O₂<1 ppm, H₂O<1 ppm; Jacomex, France) without any exposure to ambient air.

### Preparation of an Electrode Comprising Only Carbon Black and No Manganese Oxide (CE-2)

A 1:1 (wt.:wt.) mixture of Li₂O₂ and Vulcan XC-72 was added to a 0.67% wt. PEO 400K (Aldrich) solution in toluene (99.5%, <1 ppm water), wherein the ratio by weight of the binder PEO 400K to Vulcan XC-72 is 0.2. The mixture was sonicated under Ar atmosphere for 10 minutes using a Branson 250 digital probe-sonifier. The ink obtained was coated directly on Celgard® C480 using a Meyer-Rod. After evaporation of the solvent at room temperature, 15 mm diameter cathode electrodes were punched out. The electrodes were dried under dynamic vacuum overnight at 50° C. in a glass oven (Büchi, Switzerland) and directly transferred for cell assembly into an argon-filled glove box (O₂<1 ppm, H₂O<1 ppm; Jacomex, France) without any exposure to ambient air.

### Assembly and Operation of Electrochemical Test Cells

The electrolyte used was 0.2 M LiTFSI (Sigma-Aldrich, 99.99%) in diglyme (anhydrous, Aldrich, 99.5%) The water content of the electrolyte was below 8 ppm (by Karl Fischer titration). The cells were constructed in an Ar-filled glovebox (O₂<1 ppm, H₂O<1 ppm). Cells were built and used as shown and described in Electrochemical and Solid-State Letters, 15 (4) A45 (2012). A 17 mm ø lithium disk (0.45 μm thick, 99.9%; Chemetall, Germany) was used as the anode, and 40 μl of electrolyte were applied to the lithium foil. Subsequently, 2 plies of Celgard® C480 separator were placed on and further 40 μl of electrolyte were added to the separators. Subsequently, the cathode (first cell: electrode E-1; second cell; electrode CE-2) was placed on and further 40 μl of electrolyte were added. 21 mm ø stainless steel (316SS) mesh (0.22 mm ø wire, 1.0 mm openings, Spoil KG, Germany) was also used as an output conductor on the cathode side. The cells were sealed with four screws at a torque of 6 Nm and charged galvanostatically at 120 mA/g_{carbon} using a VMP3 multi-potentiostat (Biologic, France).

The electrochemical cell comprising the electrode comprising Catalyst-2 (E−1) is charged at a voltage of around 200 mV lower than the comparative electrochemical cell comprising electrode (CE-2) comprising no manganese oxide.

1. A process for producing a carbon-supported manganese oxide catalyst comprising
(A) carbon in an electrically conductive polymorph and
(B) manganese oxide of formula (I)
MnOₓ (I),
wherein x is in the range from 1 to 2,
the process comprising:
(a) reducing permanganate MnO₄⁻ in the presence of a suspension of carbon in an electrically conductive polymorph in at least one aprotic, polar solvent thereby forming a carbon-supported manganese oxide, wherein the oxidation state of manganese is in the range from 2 to 4,
(b) isolating the carbon-supported manganese oxide, and
(c) optionally treating thermally the isolated carbon-supported manganese oxide of (b) in a temperature range from 100° C. to 600° C.

2. The process according to claim 1, wherein the carbon in an electrically conductive polymorph is carbon black.

3. The process according to claim 1, wherein the aprotic, polar solvent is acetone.

4. The process according to claim 1, wherein the reduction of permanganate MnO₄⁻ occurs in the presence of water in an amount of 0.001 to 10% by weight based on the sum of the aprotic, polar solvents.

5. The process according to claim 1, wherein (a) occurs at a temperature in the range from 20 to 80° C.

6. The process according to claim 1, wherein a solution of KMnO₄ in acetone is added drop-wise to a suspension of carbon black in acetone in a temperature range from 20° C. to 55° C.

7. A carbon-supported manganese oxide catalyst comprising
(A) carbon in an electrically conductive polymorph and
(B) manganese oxide of formula (I)
MnOₓ (I),
wherein x is in the range from 1 to 2,
wherein the carbon-supported manganese oxide catalyst is obtained by the process according to claim 1.

8. (canceled)

9. A gas diffusion electrode comprising the carbon-supported manganese oxide catalyst according to claim 7 and at least one solid medium through which gas can diffuse and which optionally serves as a carrier for the carbon-supported manganese oxide catalyst.

10. (canceled)

11. An electrochemical cell comprising a gas diffusion electrode according to claim 9.

12. (canceled)

13. A rechargeable lithium-air battery comprising an electrochemical cell according to claim 11.

14. A motor vehicle, a bicycle operated by an electric motor, an aircraft, a ship, or a stationary energy store comprising the electrochemical cell according to claim 11.
